(19) United States
(12) Patent Application Publication
(10) Pub. No.: US 2025/0113218 A1
(43) Pub. Date: Apr. 3, 2025

(54) Federated Learning for Automated Selection of High Band MM Wave Sectors

(71) Applicant: Northeastern University, Boston, MA (US)

(72) Inventors: Kaushik CHOWDHURY, Needham, MA (US); Debashri ROY, Arlington, MA (US)

(21) Appl. No.: 18/834,432

(22) PCT Filed: Feb. 27, 2023
(86) PCT No.: PCT/US2023/013941

§ 371 Date: Jul. 30, 2024

Related U.S. Application Data
(60) Provisional application No. 63/314,336, filed on Feb. 25, 2022.
(60) Provisional application No. 63/314,919, filed on Feb. 28, 2022.

(51) Int. Cl. H04W 24/02; G06N 20/00; H04W 4/44; H04W 48/16

(52) U.S. Cl. CPC H04W 24/02; G06N 20/00; H04W 4/44; H04W 48/16

(57) ABSTRACT

Provided herein are systems and methods for selecting a mm wave network sector for use by a vehicle operating within a network environment, the method including collecting data from a plurality of non-RF sensors on the vehicle, training, by the collected data in a deep learning inference (DL) engine, a locally trained model analyzing, using the trained model and the DL engine, the collected data to predict a sector of the mm wave network having a best alignment at a position of the vehicle; and probing the predicted sector of the mm wave network.

### CROSS REFERENCE TO RELATED APPLICATIONS

This application claims benefit under 35 U.S.C. § 119 (e) of U.S. Provisional Application No. 63/314,336, filed on 25 Feb. 2022, entitled “Federated Learning for Automated Selection of High Band mm Wave Sectors,” and of U.S. Provisional Application No. 63/314,919, filed on 28 Feb. 2022, entitled “Federated Learning for Automated Selection of High Band mm wave Sectors,” the entirety of each of which is incorporated by reference herein.

### STATEMENT REGARDING FEDERALLY SPONSORED RESEARCH OR DEVELOPMENT

This invention was made with government support under Grant Nos. 2112471 and 1937500 awarded by the National Science Foundation. The government has certain rights in the invention.

### BACKGROUND

Fast sector-steering in the mm wave band for vehicular mobility scenarios remains an open challenge. This is because standard-defined exhaustive search over predefined antenna sectors cannot be assuredly completed within short contact times.

Autonomous cars are equipped with multiple sensors that stream high volumes of locally recorded data to a central cloud, which requires multi-Gbps transmission rates. These data are needed for safety-critical tasks such as enhanced situational awareness, driving directives generation, and pedestrian safety, and may involve further processing at a mobile edge computing (MEC). Given the limited bandwidth in the sub-6 GHz band, the millimeter-wave (mm wave) band is an ideal candidate for vehicle-to-everything (V2X) communications. As an example, emerging standards offer up to 2 GHz wide channels within the untapped spectrum resources available in the 57-72 GHz frequency range.

To fully unlock the potential of mm wave-band operation, directional antennas are used to address the severe attenuation and penetration loss that is characteristic of high frequency transmissions. Such antenna arrays manipulate steering directivity during runtime by changing the gain and phase of each antenna element. However, an exhaustive search of all possible configurations results in a large overhead. Hence, current standards, such as IEEE 802.11ad, prescribe a set of predefined patterns, referred to as sectors, with a deterministic sweeping algorithm that selects the optimal sector with the strongest mm wave link between transmitter (Tx) and receiver (Rx). The 802.11ad standard, in particular, proposes an exhaustive search of all sectors. This process is time-consuming as it involves probing each sector through a bi-directional packet exchange, especially for mobility scenarios where the optimal sectors may dynamically change.

Attempts have been made to make use of auxiliary information to reduce the sector selection overhead. Steinmetzer et al. propose a compressive path tracking algorithm where the measurements on a random subset of sectors are used to estimate the optimum sector. Palacios et al. leverage the coarse received signal strength to extract full channel state information (CSI) and account for the overhead imposed by sector training. Saha et al. present a comprehensive analysis of practical measurements on two commercial off-the-shelf (COTS) devices and explore the trade-off between training overhead and sector selection accuracy. Sur et al. propose to exploit the CSI at sub-6 GHz band to infer the optimum sector at mm wave band, though it does not support simultaneous beamforming at both the Tx and Rx.

With regard to machine learning (ML)-based approaches, Va et al. use the location of all nearby vehicles, including the target Rx, as the input for their sector inference algorithm, while Alrabeiah et al. combine both camera images and a recorded sequence of previous sectors to model dynamic mm wave communication in outdoor scenarios. Klautau et al. and Dias et al. propose to reduce the sector search space using GPS and LiDAR sensors in vehicular settings. On the other hand, Muns et al. use GPS and camera images to speed up the beam selection.

Nevertheless, none of this literature considers real-world experiments on live sensor data. Moreover, all of the above techniques focus on a centralized system with the challenge of high bandwidth data transfer through a control channel, which is susceptible to saturation and malicious degradation. Furthermore, although prior work in connection with federated learning (FL) provides frameworks to mitigate the aforementioned risks of saturation and malicious degradation by reducing overhead, and additional recent works have attempted to further reduce such overheads, the fundamental risks remain of concern for any centralized system reliant on a control channel.

### SUMMARY

Provided herein are methods and systems for federated learning for automated selection of high band mm wave sectors. In general, machine learning (ML) is implemented for speeding up sector selection using data from multiple non-RF sensors, such as LiDAR, GPS, and camera images. A multimodal deep learning architecture is described herein for fusing these disparate data inputs to locally predict sectors for best alignment at a vehicle. In addition, the impact and mitigation of missing data (e.g., missing LiDAR/images) during inference (typically the result of unreliable control channels or hardware malfunctions) is also described herein. Furthermore, a first-of-its-kind multimodal federated learning framework is described. The multimodal federated learning framework combines model weights from multiple vehicles and then disseminates the final fusion architecture back to them, thus incorporating private sharing of information and reducing each vehicle's individual training times.

These architectures were tested on a live dataset collected from an autonomous car equipped with multiple sensors (GPS, LiDAR, and camera) and roof-mounted Talon AD7200 60 GHz mm wave radios. During test, a 52.75% decrease in sector selection time was observed as compared to 802.11ad standard while maintaining 89.32% throughput with the globally optimal solution.

In one aspect, a method is provided for selecting a mm wave network sector for use by a vehicle operating within a network environment. The method includes collecting data from a plurality of non-RF sensors on the vehicle. The method also includes training, by the collected data in a deep learning inference (DL) engine, a locally trained model. The method also includes analyzing, using the trained model and the DL engine, the collected data to predict a sector of the mm wave network having a best alignment at a position of the vehicle. The method also includes probing the predicted sector of the mm wave network.

In some embodiments, the step of probing also includes receiving a test sample from a mobile edge computing (MEC) node of the network environment. In some embodiments, the method also includes passing the test sample through the local model via the DL engine to calculate an average inference delay of the network environment. In some embodiments, the plurality of non-RF sensors includes at least one of a LIDAR, a GPS, still images, video, or combinations thereof. In some embodiments, the method also includes providing the local multimodal model to a mobile edge computing (MEC) node of the network environment for aggregation to a global shared model. In some embodiments, the method also includes receiving, from the MEC node, at least a portion of the aggregated global shared model. In some embodiments, the method also includes collecting data from a plurality of non-RF sensors on at least one different vehicle operating within the network environment. In some embodiments, the step of analyzing the collected data includes analyzing the data collected from both the vehicle and the at least one different vehicle. In some embodiments, the method also includes providing the data collected from the plurality of non-RF sensors on the vehicle to at least one different vehicle operating within the network environment. In some embodiments, the step of training the locally trained model includes executing an algorithm:

```
Input: Intial parameters θᵥ^{FN(0)} = θ^{FN(0)} ∀v ∈ V(at vehicles)
    P = {α, β, γ, δ}, where α + β + γ + δ = 1 (at MEC)
  Output: Trained global model weights θᵥ^{B(i)}
  For each i = 1 ... N do
  θᵥ^{FN(i)} = local training for ξ ephs on θᵥ^{FN(i-1)} (at vehicles)
  Each participant vehicle v shares θᵥ^{FN(i)} to MEC
  Assign four branches B_{c}⁽ⁱ⁾, B_{I}⁽ⁱ⁾, B_{L}⁽ⁱ⁾, B_{IN}⁽ⁱ⁾ within θᵥ^{FN(i)}
  B(i) = P_{P}(B_{c}⁽ⁱ⁾, B_{I}⁽ⁱ⁾, B_{L}⁽ⁱ⁾, B_{IN}⁽ⁱ (at MEC)
  MEC computes
  ${θ}^{B ( i )} = \frac{1}{\vert V \vert} {\sum }_{v = 1}^{V} {θ}_{v}^{B ( i )}$
  MEC distributes θ^{B(i)} such that θᵥ^{B(i)} = θ^{B(i)} ∀v ∈ V
  End
```

wherein the Intial parameters θᵥ^{FN(0)} are determined from the collected data.

In another aspect, a system for selecting a mm wave network sector for use by a vehicle operating within a network environment is provided. The system includes a plurality of non-RF sensors mounted on the vehicle. The system also includes a mm wave receiver mounted on the vehicle. The system also includes an analysis module programmed to perform the method of claim 1.

In some embodiments the plurality of non-RF sensors includes at least one of a LIDAR, a GPS, still images, video, or combinations thereof. In some embodiments, the system also includes a plurality of the vehicles, wherein each vehicle includes a plurality of non-RF sensors and a mm wave receiver mounted thereon. In some embodiments, the system also includes a mobile edge computing (MEC) node programmed to collect the local model from each of the plurality of vehicles, aggregate the local models to at least one branch of a plurality of weighted branches of the global shared model according to previous-iteration model weights to generate at least one updated branch of the global shared model; and disseminate the updated branch or branches to the vehicles. In some embodiments, the MEC assigns four different branches within the current model weights θᵥ^{FN(i)} and chooses one of them B(i) using the stochastic function P_{P}(•). In some embodiments, the weights of the selected branch B(i) of each received model are averaged by the MEC and sent back to the participating vehicles. In some embodiments, each vehicle responsively updates the selected branch of their local models and executes the local training for the next federated iteration. In some embodiments, the system also includes an orchestration module for executing the choosing of the branch B(i) using the stochastic function.

In some embodiments, the collected data includes GPS, camera, and LiDAR data, sorted as a local dataset Dᵥ={X_{C,v},X_{I,v},X_{L,v}}ᵥ₌₁^{v}. In some embodiments a data matrix for GPS, image, and LiDAR at the vehicle v is expressed as X_{C,v}∈ [symbol] ^{N}^{×2},X_{I,v}∈ [symbol] ^{N}^{ₜ}^{×d}^{₀} ^{^{I}}^{×d}^{₁}^{^{I}},X_{L,v}∈ [symbol] ^{N}^{ₜ}^{×d}^{₀}^{^{L}}^{×d}^{₁}^{^{L}}^{×d}^{₂}^{^{L}} respectively, where Nₜ is the number of training samples. In some embodiments dimensionality of collected image data is expressed as (d₀^{I}×d₁^{I}). In some embodiments dimensionality of preprocessed lidar data is expressed as (d₀^{L}×d₁^{L}×d₂^{L}).

Additional features and aspects of the technology include the following:
1. A method for selecting a mm wave network sector for use by a vehicle operating within a network environment, the method comprising:
   collecting data from a plurality of non-RF sensors on the vehicle;
   training, by the collected data in a deep learning inference (DL) engine, a locally trained model;
   analyzing, using the trained model and the DL engine, the collected data to predict a sector of the mm wave network having a best alignment at a position of the vehicle; and probing the predicted sector of the mm wave network.
2. The method of feature 1, wherein the step of probing further comprises:
   receiving a test sample from a mobile edge computing (MEC) node of the network environment; and
   passing the test sample through the local model via the DL engine to calculate an average inference delay of the network environment.
3. The method of any of features 1-2, wherein the plurality of non-RF sensors includes at least one of a LIDAR, a GPS, still images, video, or combinations thereof.
4. The method of any of features 1-3, further comprising providing the local multimodal model to a mobile edge computing (MEC) node of the network environment for aggregation to a global shared model.
5. The method of feature 4, further comprising receiving, from the MEC node, at least a portion of the aggregated global shared model.
6. The method of any of features 1-5, further comprising collecting data from a plurality of non-RF sensors on at least one different vehicle operating within the network environment.
7. The method of feature 5, wherein the step of analyzing the collected data includes analyzing the data collected from both the vehicle and the at least one different vehicle.
8. The method of any of features 1-7, further comprising providing the data collected from the plurality of non-RF sensors on the vehicle to at least one different vehicle operating within the network environment.
9 The method of any of features 2-8, wherein the step of training the locally trained model includes executing an algorithm:

```
Input: Intial parameters θᵥ^{FN(0)} = θ^{FN(0)} ∀v ∈ V(at vehicles)
    P = {α, β, γ, δ}, where α + β + γ + δ = 1 (at MEC)
  Output: Trained global model weights θᵥ^{B(i)}
  For each i = 1 ... N do
  θᵥ^{FN(i)} = local training for ξ ephs on θᵥ^{FN(i-1)} (at vehicles)
  Each participant vehicle v shares θᵥ^{FN(i)} to MEC
  Assign four branches B_{c}⁽ⁱ⁾, B_{I}⁽ⁱ⁾, B_{L}⁽ⁱ⁾, B_{IN}⁽ⁱ⁾ within θᵥ^{FN(i)}
  B(i) = P_{P}(B_{c}⁽ⁱ⁾, B_{I}⁽ⁱ⁾, B_{L}⁽ⁱ⁾, B_{IN}⁽ⁱ (at MEC)
  MEC computes
  ${θ}^{B ( i )} = \frac{1}{\vert V \vert} {\sum }_{v = 1}^{V} {θ}_{v}^{B ( i )}$
  MEC distributes θ^{B(i)} such that θᵥ^{B(i)} = θ^{B(i)} ∀v ∈ V
  End
```

wherein the Intial parameters θᵥ^{FN(0)} are determined from the collected data.
10. A system for selecting a mm wave network sector for use by a vehicle operating within a network environment, the system comprising:
   a plurality of non-RF sensors mounted on the vehicle;
   a mm wave receiver mounted on the vehicle; and
   an analysis module programmed to perform the method of claim 1.
11. The system of feature 10, wherein the plurality of non-RF sensors includes at least one of a LIDAR, a GPS, still images, video, or combinations thereof.
12. The system of any of features 10-11, further comprising:
   a plurality of the vehicles, wherein each vehicle includes a plurality of non-RF sensors and a mm wave receiver mounted thereon; and
   a mobile edge computing (MEC) node programmed to:
      collect the local model from each of the plurality of vehicles
      aggregate the local models to at least one branch of a plurality of weighted branches of the global shared model according to previous-iteration model weights to generate at least one updated branch of the global shared model; and
      disseminate the updated branch or branches to the vehicles.
13. The system of feature 12, wherein the MEC assigns four different branches within the current model weights of θᵥ^{FN(i)} and chooses one of them B(i) using the stochastic function P_{P}(•).
14. The system of feature 13, wherein the weights of the selected branch B(i) of each received model are averaged by the MEC and sent back to the participating vehicles.
15. The system of feature 14, wherein each vehicle responsively updates the selected branch of their local models and executes the local training for the next federated iteration.
16. The system of any of features 13-15, further comprising an orchestration module for executing the choosing of the branch B(i) using the stochastic function.
17. The system of any of features 12-16, wherein the collected data includes GPS, camera, and LiDAR data, sorted as a local dataset Dᵥ={X_{C,v},X_{I,v},X_{L,v}}ᵥ₌₁^{v}.
18. The system of feature 17, wherein a data matrix for GPS, image, and LiDAR at the vehicle v is expressed as X_{C,v}∈ [symbol] ^{N}^{ₜ}^{×2},X_{I,v}∈ [symbol] ^{N}^{ₜ}^{×d}^{₀}^{^{I}}^{×d}^{₁}^{I},I_{L,v}∈ [symbol] ^{N}^{ₜ}^{×d}^{ₒ}^{^{L}}^{×d}^{₁}^{^{L}}^{×d}^{₃}^{L} respectively, where Nₜ is the number of training samples.
19. The system of feature 18, wherein:
   dimensionality of collected image data is expressed as (d₀^{I}×d₁^{I}); and
   dimensionality of preprocessed lidar data is expressed as (d₀^{L}×d₁^{L}×d₂^{L}).

### BRIEF DESCRIPTION OF THE DRAWINGS

FIG. 1 illustrates a schematic of a multimodal federated learning (FL) framework (hereinafter “FLASH”) for mm wave vehicular networks, where each vehicle is equipped with GPS, LiDAR and camera sensors.

FIG. 2 illustrates multimodal FL training, orchestration, aggregations, and reporting each occupying specific time windows within each iteration of FLASH.

FIG. 3 illustrates synergic local and multimodal federated training of FLASH. The local training happens on the multimodal data, the orchestrator selects one of the branches from a fusion network (FN) for federated averaging (highlighted ‘LiDAR’ for example) in each iteration.

FIG. 4 illustrates an inference pipeline for sector prediction at each vehicle. The inference engine enhances the trained neural network models with the added feature of adaptation to missing information.

FIG. 5A illustrates a top view of an experimental testbed location used to demonstrate FLASH.

FIG. 5B illustrates an experimental setup used to demonstrate FLASH.

FIG. 6 illustrates a schematic of a data collection environment for each of a Category 1: LOS passing data collection, a Category 2: NLOS pedestrian data collection, a Category 3: NLOS static car data collection, and Category 4: NLOS moving car data collection. See Tab. I below for a summary of each category of collected dataset.

FIG. 7 illustrates an exemplary synchronization scheme.

FIG. 8A illustrates a FL network architecture for GPS networks using multiple convolutional and fully connected (FC) layers.

FIG. 8B illustrates a FL network architecture for image networks using multiple convolutional and fully connected (FC) layers.

FIG. 8C illustrates a FL network architecture for LiDAR networks using multiple convolutional and fully connected (FC) layers.

FIG. 8D illustrates a FL network architecture for integration networks designed for concatenating selected layers from each of the unimodal models of FIGS. 8A-8C.

FIG. 9 illustrates average achieved top-1 accuracy of local training and global inference over all tested vehicles. The error bars depict the variance in top-1 accuracies among all vehicles. See Tab. II below for a listing of the underlying data.

FIG. 10A illustrates performance of federated training and global inference over 90 rounds of aggregation.

FIG. 10B illustrates a comparison of the performance of FL with an increasing number of vehicles and amount of federated training.

FIG. 10C illustrates a comparison of the performance of 802.11ad and FLASH with respect to throughput ratio and end-to-end sector selection time.

FIG. 11A illustrates performance of resilient inferencing when all three modalities are missing with probability p=0:1; 0:5; 0:9. The sensor data is looped back to different sample values presented in the x-axis.

FIG. 11B illustrates tolerance of the FLASH framework when different combinations of sensor modalities are missing.

### DETAILED DESCRIPTION

Fast sector-steering in the mm wave band for vehicular mobility scenarios remains an open challenge. This is because standard-defined exhaustive search over predefined antenna sectors cannot be assuredly completed within short contact times. As described herein, machine learning (ML) is implemented for speeding up sector selection using data from multiple non-RF sensors, such as LiDAR, GPS, and camera images. A multimodal deep learning architecture is described herein for fusing these disparate data inputs to locally predict sectors for best alignment at a vehicle. In addition, the impact and mitigation of missing data (e.g., missing LiDAR/images) during inference (typically the result of unreliable control channels or hardware malfunctions) is also described herein. Furthermore, a first-of-its-kind multimodal federated learning framework is described. The multimodal federated learning framework combines model weights from multiple vehicles and then disseminates the final fusion architecture back to them, thus incorporating private sharing of information and reducing each vehicle's individual training times.

The described architectures were tested on a live dataset collected from an autonomous car equipped with multiple sensors (GPS, LiDAR, and camera) and roof-mounted Talon AD7200 60 GHz mm wave radios. During test, a 52.75% decrease in sector selection time was observed as compared to 802.11ad standard while maintaining 89.32% throughput with the globally optimal solution.

As indicated above, the state-of-the-art solves the problem of beam selection in mm wave band by: (i) probing all the sectors in 802.11d, (ii) extracting full channel state information, (iii) compressive path tracking algorithm, (iv) exploits channel state information at Sub-6 GHz to infer the optimum sector at high-band mm wave frequencies, (v) use of GPS and LiDAR sensor data to reduce the sector search space at mm wave band. Nevertheless, none of this literature considers real-world experiments on live sensor data. Moreover, all of the above techniques focus on a centralized system with the challenge of high bandwidth data transfer through a control channel, which is susceptible to saturation and malicious degradation.

The methods and systems for federated learning for automated selection of high band mm wave sectors provided herein overcome these problems by using multimodal sensing data for mm wave sector selection in V2X nextG communication in a distributed federated learning framework.

### Sector Selection Using Multimodal Data

Due to the quasi-optical behavior of propagation in the mm wave band, the sector selection process solves the problem of locating the strongest signal for line of sight (LOS) paths, or detecting the strongest reflection for non-line of sight (NLOS) paths. Thus, the locations of the Tx, Rx, and potential obstacles play an important role in the sector selection process. Interestingly, all of this information is also embedded in the situational state of the environment that is acquired through monitoring sensor devices such as GPS (Global Positioning System), cameras, and LiDAR (Light Detection and Ranging), which provides a 3-D mapping of the surroundings. These sensors are present in autonomous vehicles to aid in driving but can also be re-purposed to optimize communication links. Furthermore, with regard to mapping, using multiple modalities increases resilience, wherein missing information from a particular sensor type can be compensated by utilizing data from the others, with graceful degradation of performance.

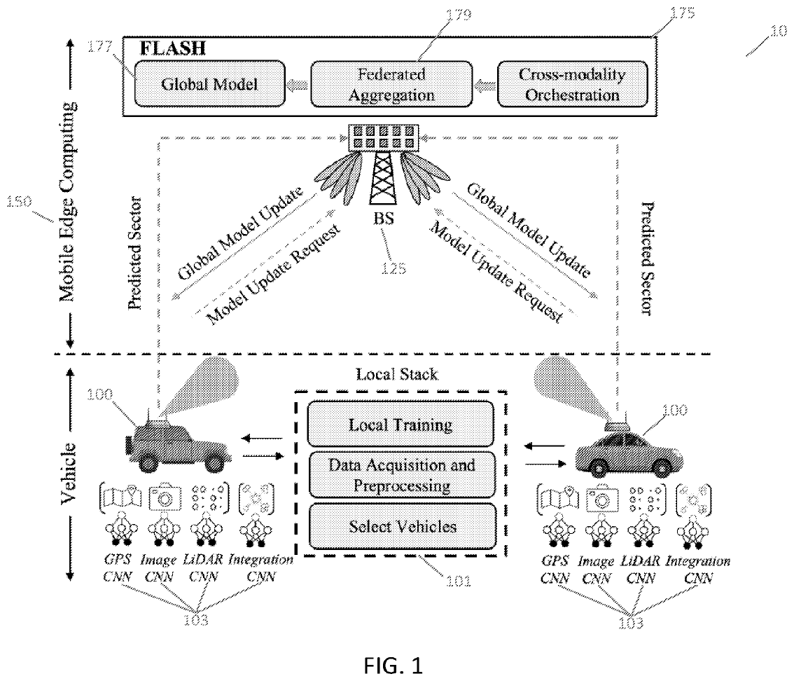

FIG. 1 illustrates a scenario of interest within a system 10 for federated learning for automated selection of high band mm wave sectors with multiple moving vehicles 100 and a roadside base station (BS) 125 attempting to find the best sector for the downlink transmission from the BS 125 to the vehicle 100. Described herein is a deep learning (DL) framework that uses non-RF sensor data to select the best sector to probe without attempting an exhaustive search. Once the best sector is determined, the BS 125 starts the multi-Gbps downlink transmission to the vehicle 100 instantaneously. A DL based inference engine 101 in each vehicle 100 is resilient to missing data; even if some data modalities are missing at any given time, the engine 101 is capable of generating remarkably accurate predictions of the best sector. It is worth noting that multiple sensors are now included as standard installations both in modern cars and roadside infrastructures: LiDAR and camera sensors are already indispensable parts of modern vehicles, used for driving corrections and collision avoidance; GPS data is regularly collected and transmitted as part of basic safety messages in V2X applications.

### Federated Learning on Multiple Modalities

DL architectures benefit from the availability of large amounts of data. When data is collected by an individual vehicle for local training, the accuracy of the model, a Deep Neural Network (DNN), may be impacted due to a limited training dataset that may not capture the diversity of other practical deployment scenarios. The vehicles must have the latest trained models available on-board when entering the network, which is difficult to accomplish without a framework for model sharing.

Still referring to FIG. 1, a federated learning (FL) architecture 175 is one candidate solution to mitigate these issues. In this form of learning, local network models 103 are collected from the vehicles 100, aggregated to a global shared model 177 at the mobile edge computing (MEC) 150, and then disseminated back to the vehicles 100 for local inference as shown in FIG. 1. Thus, vehicles 100 collaboratively participate in learning the shared prediction model while keeping the raw training data in the vehicles 100 instead of requiring the data to be uploaded and stored on a central server. This process is important for high-speed vehicular scenarios, as locally trained models 103 can be updated on hidden obstacles and the unseen environment previously detected by other vehicles. Such a distributed FL architecture also allows the most updated models to be available to new vehicles that are entering the network environment. It is assumed that each vehicle has the necessary computation power to train and infer local machine learning (ML) models 101 and refer to such vehicles as semi-autonomous edge nodes, distinguishing them from the centralized MEC 150. Moreover, a sub-6 GHz control channel was used to relay model weight updates.

Note that using a multitude of sensor modalities improves the prediction performance by providing a comprehensive representation of the environment. Moreover, it gives the flexibility to adjust the contribution of each modality to the federated aggregation 179 iterations according to their performance optimality on a case-by-case basis. For example, GPS works reliably in LOS-dominant environments, such as open freeways, while LiDAR, giving a 3-D representation, is more effective in an NLOS-heavy environment such as an urban canyon, where buildings flank the road on both sides. Besides, LiDAR and camera performances are prone to errors in the presence of strong sunlight reflections and low light conditions, respectively. Hence, a selective approach may improve the overall performance by being biased towards situationally-favored modalities.

### List of Example Features

Robust DL architectures are described that predict the best sector using non-RF sensor data from devices such as GPS, camera, and LiDAR, wherein the processing steps are contained within the semi-autonomous edges (vehicles). It is shown that adding more viewpoints in the training data enhances the performance of sector selection and analyze the resulting control overhead.
A multimodal FL framework (hereinafter “FLASH”) is described, where local DL model weights are globally optimized by fusing them at the MEC. So far, the state-of-the-art in FL has focused on unimodal data, which suggests that FLASH may be suitable for other generalized problems involving multiple data types (beyond mm wave beamforming).
A multimodal data adaptation technique is described, which is executed in the individual vehicles, making FLASH resilient to missing sensor information. It is observed 67.59% top-1 accuracy even when all sensors are missing for 10 consecutive samples.
The end-to-end latency of FLASH is rigorously analyzed and compared with IEEE 802.11ad standard and it is demonstrated that sector selection time decreases by 52.75% on average while maintaining 89.32% of the throughput. Due to lack of access to programmable cellular 5G mm wave BS and clients, two 802.11ad-enabled mm wave Talon routers are used to evaluate FLASH in real-world scenarios. Without loss of generality, FLASH can be applied to other bands and wireless standards.
The first dataset collected by an autonomous vehicle mounted with multimodal sensors and mm wave radios is published. The dataset includes comprehensive settings of LOS and NLOS scenarios for the urban canyon region.

### Flash System Architecture

This section begins with a review of classical sector initialization methods and then describes a distributed system architecture in accordance with various embodiments that uses non-RF data from multiple sensors.

### Traditional Beam Initialization

The IEEE 802.11ad standard sector initialization steps consist of two stages that starts with a mandatory sector level sweep (SLS) and follows with an optional beam refinement process (BRP). During SLS, two end-nodes referred to as the initiator and responder jointly explore different sectors in order to detect the best one. First, the initiator transmits a probe frame from each sector, while the responder listens to these frames in a quasi-omni-directional antenna setting. This process is then repeated with the initiator and responder roles reversed. In the SLS phase, a complete frame must be transmitted at each sector in the lowest PHY rate, incurring a time cost of for only 34 sectors. The BRP is used to fine-tune the sectors detected in the SLS phase. As it uses only one frame, the BRP imposes much less overhead. Hence, the focus of this disclosure is on the SLS phase because it generates the largest overhead.

### Problem Statement

Consider a Tx and Rx pair equipped with phased antenna arrays with a predefined codebook defined by

C_{Tx}={t₁, . . . , t_{M}}, C_{Rx}={r₁, . . . , r_{N}} including M and N elements, respectively. A total of M+N probe frames must be transmitted to complete the SLS and the sector that returns the maximum received signal strength is then selected as the optimum sector. For example, the optimum sector at Tx is derived by:

$${t}^{*} = arg max {y}_{{t}_{m}} \\ 1 \leq m \leq M \qquad ( 1 )$$

with yₜ_{ₘ} being the observed received signal strength at the Rx side when the transmitter is configured at sector tₘ.

### FLASH With Multimodal Learning

In view of the above, it is noted that the training time scales linearly with the number of sectors in the codebook and this cannot be timely completed for a vehicular network with a high number of sectors. Thus, a learning framework is described to exploit multiple sensor measurements that can directly estimate the best sector t* in one shot and then immediately start the transmission. This solution includes the following four components:

Data Acquisition and Preprocessing: The collected sensor data first passes through the preprocessing phase. For LiDAR, a quantization technique is employed that incorporates the BS and vehicle position to mark the transmitter and target Rx in point clouds and the remaining detected objects as obstacles. A new coordinate system is also defined to effectively merge the decimal degree GPS and metric LiDAR measurements.

Local Training at the Semi-autonomous Edge: Given preprocessed multimodal sensor data, a fusion architecture is designed that is trained using local data (e.g., the data available at a given vehicle or each semi-autonomous edge). A novel fusion network is designed that combines all the modalities for the local training.

Multimodal Federated Training: Given the locally trained models for each unimodal and fusion network, a multimodal FL-based architecture is described as a global optimization technique.

Resilient Inference: Finally, measures are included to make the inference through the trained and optimized fusion architecture adaptive to the unavailable sensor data at the edge.

### Flash Framework Design

### Data Acquisition and Preprocessing

Multimodal data from GPS, camera, and LiDAR sensors is collected and passed through preprocessing steps as follows.

LiDAR Preprocessing: To process the LiDAR data, a quantized view of the spatial extent of the surroundings is constructed. This data structure resembles a stack of cuboid regions placed adjacent to each other. The LiDAR point clouds reside in the cuboid regions according to their relative distances as measured from a shared origin. The cuboids that contain blocking obstacles are marked using label 1. Since the coordinates of the Tx and Rx are known, the cuboids containing them are labeled as −1 and −2, respectively.

GPS Coordinate System: The raw GPS coordinates recorded at the vehicle are in DecimalDegree; however, the LiDAR data are in meters. A fixed origin is considered and absolute distances from that origin are calculated to define a Cartesian coordinate system. With regard to the LiDAR system, points are measured with respect to the sensor location (in this case, the vehicle position). Thus, the LiDAR point clouds are adjusted by the difference between two origins pertaining to the GPS and LiDAR coordinate systems.

```
ALGORITHM 1: Multimodal federated training
Input: Intial parameters θᵥ^{FN(0)} = θ^{FN(0)} ∀v ∈ V(at vehicles)
    P = {α, β, γ, δ}, where α + β + γ + δ = 1 (at MEC)
  Output: Trained global model weights θᵥ^{B(i)}
  For each i = 1 ... N do
  θᵥ^{FN(i)} = local training for ξ ephs on θᵥ^{FN(i-1)} (at vehicles)
  Each participant vehicle v shares θᵥ^{FN(i)} MEC
  Assign four branches B_{c}⁽ⁱ⁾, B_{I}⁽ⁱ⁾, B_{L}⁽ⁱ⁾, B_{IN}⁽ⁱ⁾ within θᵥ^{FN(i)}
  B(i) = P_{P}(B_{c}⁽ⁱ⁾, B_{I}⁽ⁱ⁾, B_{L}⁽ⁱ⁾, B_{IN}⁽ⁱ (at MEC)
  MEC computes
  ${θ}^{B ( i )} = \frac{1}{\vert V \vert} {\sum }_{v = 1}^{V} {θ}_{v}^{B ( i )}$
  MEC distributes θ^{B(i)} such that θᵥ^{B(i)} = θ^{B(i)} ∀v ∈ V
  End
```

### Local Training at Semi-Autonomous Edge

Consider a number of vehicles V that are in the coverage range of the BS and are trying to establish a link with the latter. Each vehicle is equipped with GPS, camera, and LiDAR sensors and collects the local dataset Dᵥ={X_{C,v},X_{I,v},X_{L,v}}ᵥ₌₁^{v}. Denoted are the data matrices for GPS, image, and LiDAR at the vehicle v as X_{C,v}∈ [symbol] ^{N}^{ₜ}^{×2},X_{I,v}∈ [symbol] ^{N}^{ₜ}^{×d}^{₀}^{^{I}}^{×d}^{₁}^{^{I}},X_{L,v}∈ [symbol] ^{N}^{ₜ}^{×d}^{₀}^{^{L}}^{×d}^{₁}^{^{L}}^{×d}^{₂}^{^{L}} respectively, where Nₜ is the number of training samples. Furthermore, (d₀^{I}×d₁^{I}) and (d₀^{L}×d₁^{L}×d₂^{L}) give the dimensionality of image and preprocessed LiDAR data, while the GPS has 2 elements, latitude and longitude. The label matrix Yᵥ∈{0,1}^{N}^{ₜ}^{×M} represents the one-hot encoding of M sectors, where the optimum sector is set to 1, and rest are set to 0 as per Eq. (1). Each vehicle uses its local dataset Dᵥ to initiate a supervised learning task. In the simplest case, the vehicles can use a DNN-based unimodal network to extract discriminative features from the input and infer the optimum sector. Each unimodal network makes a probabilistic prediction of the best sector through SoftMax layer defined as:

$${u}_{C}^{v} = σ ( {f}_{{θ}^{C}}^{v} ( {X}_{C , v} ) ) , {f}_{{θ}^{C}}^{v} : {ℝ}^{2} ↦ {ℝ}^{M} \qquad ( 2 a )$$

$${u}_{I}^{v} = σ ( {f}_{{θ}^{I}}^{v} ( {X}_{I , v} ) ) , {f}_{{θ}^{I}}^{v} : {ℝ}^{{d}_{0}^{I} \times {d}_{1}^{I}} ↦ {ℝ}^{M} \qquad ( 2 b )$$

$${u}_{L}^{v} = σ ( {f}_{{θ}^{L}}^{v} ( {X}_{L , v} ) ) , {f}_{{θ}^{L}}^{v} : {ℝ}^{{d}_{0}^{L} \times {d}_{1}^{L} \times {d}_{2}^{L}} ↦ {ℝ}^{M} \qquad ( 2 c )$$

where f_{C}^{v}(•), f_{I}^{v}(•), f_{L}^{v}(•) denotes the unimodal network for each vehicle v parameterized by θᵥ^{C},θᵥ^{I},θᵥ^{L}. On the other hand, using the data from all sensing modalities can boost the prediction performance. Hence, a fusion network is provided that includes four DNNs, three unimodal networks (Eq. 2), and an integration network f_{IN}^{v}(•) parameterized by θᵥ^{IN}, as presented in FIG. 1. Formally,

$${f}_{{θ}^{FN}}^{v} = {f}_{{θ}^{IN}}^{v} ( {f}_{{θ}^{c}}^{v} ( . ) , {f}_{{θ}^{I}}^{v} ( . ) , {f}_{{θ}^{L}}^{v} ( . ) ) \qquad ( 3 a )$$

$${u}_{FN}^{v} = {f}_{{θ}^{FN}}^{v} ( {X}_{C , v} , {X}_{I , v} , {X}_{L , v} ) \qquad ( 3 b )$$

where f_{FN}^{v}(•) is the fusion model parameterized by θᵥ^{FN}. Finally, the prediction happens at the output of fusion network through the computation of s=σ(u_{FN}^{v}). The sector that has highest score is chosen as the predicted sector. Each component of the fusion network is referred to as a branch; e.g., (a) GPS branch (B_{C}),f_{θ}_{^{C}}^{v}(•); (b) image branch (B_{I}), f_{θ}_{^{I}}^{v}(•); (c) LiDAR branch (B_{L}), f_{θ}_{^{L}}^{v}(•); and (d) integration branch (B_{IN}), f_{θ}_{^{IN}}^{v}(•).

### Multimodal Federated Training

The federated training architecture is composed by the local model training at the edge and federated aggregation deployed at the MEC. The global optimization of the local models requires the vehicles to periodically exchange and synchronize the model parameters θᵥ^{FN}. However, these parameter exchanges and synchronizations impose overhead in both the uplink and downlink control channels, calculated as:

[symbol]

=Σᵢ₌₁^{N}Vᵢ×(|θᵥ^{FN}|), and [symbol] =N×(|θᵥ^{FN}|) float32 variables, where |θᵥ^{FN}|=|θᵥ^{C}|+|θᵥ^{I}|+|θᵥ^{L}|+|θᵥ^{IN}|, N is the total number of federated iterations, and Vᵢ is the number of participating vehicles in the i^{th} iteration.

Given the depth of the DNNs, sharing all the locally trained weights for the three different unimodal and one integration models to the MEC occupies approximately 320 Mb of uplink and downlink channels. To address this problem, FLASH transmits the fusion network to the MEC in the uplink control channel with overhead of [symbol] =|θᵥ^{FN}| float 32 variables. A multimodal orchestrator is provided at the MEC, which retrieves four branches (B_{C}, B_{I}, B_{L}, B_{IN}) from the received network and stochastically selects one branch to be aggregated. The updated branch is then sent back through the downlink transmission. This lowers the overhead in the downlink channel to [symbol] =N×(|θᵥ^{B}^{_{b}}⁽ⁱ⁾|) float 32 variables, b∈{C,I,L,IN}.

Algorithm for multimodal federated training: In Alg. 1, the overall fusion network is initialized with the weights from the previous iteration at each vehicle (random initialization is used at first iteration). An update rate for GPS coordinates, image, LiDAR, and integration branches are defined according to a probability distribution P={α, β, γ, δ}, α+β+γ+δ=1, where the parameters α, β, γ, δ denote the probability of selecting the GPS, Image, LiDAR and integration branches for aggregation, respectively. For each federated iteration i, ranging from 1 to N, local training is performed using the model with the weights from earlier iteration, θᵥ^{FN(i-1)}, for ζ epochs, and generate updated model weights θᵥ^{FN(i)}. Next, the MEC assigns four different branches within the current model weights θᵥ^{FN(i)} and chooses one of them B(i) using the stochastic function P_{P}(•). The weights of the selected branch B(i) of each received model are averaged and sent back to the participating vehicles. Straightforward averaging of the weights is used as a federated aggregation method. The vehicles update the selected branch of their local models and execute the local training for the next federated iteration. The problem of sector selection is restricted to a fixed candidate set, making the local data independent and identically distributed (IID).

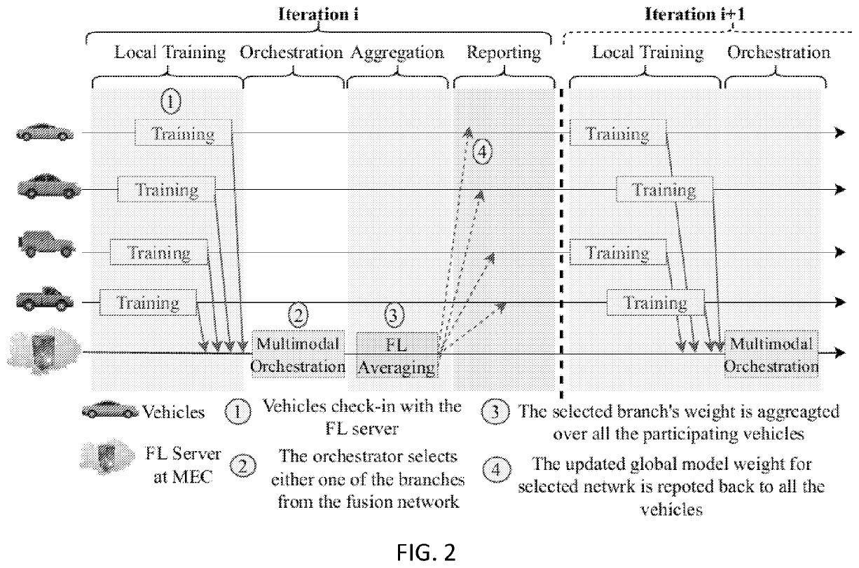

FL protocol in FLASH: In general, the federated training includes of local training, aggregation, and reporting. However, for handling multimodal data, an orchestration module is added between the local training and aggregation steps of the FL protocol flow. In this orchestration step, the stochastic selection of a specific branch is performed as discussed in Alg. 1. The overall operation over consecutive iterations is shown in FIG. 2, with the time windows for the local training, multimodal orchestration, federated aggregation, and reporting displayed. The time window for each step is defined based on the application requirements.

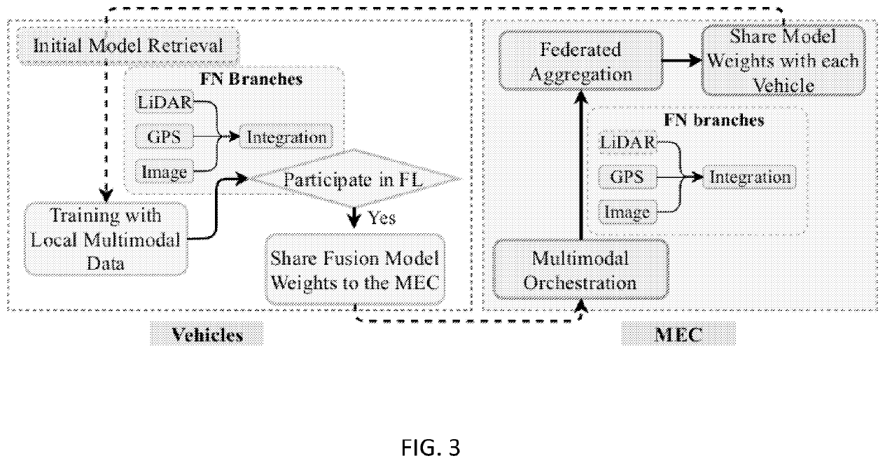

FL training in FLASH: An overview of the multimodal FL training is presented in FIG. 3. The initial model retrieval block is used to download the most updated global model from the MEC to the new vehicle as it comes within the coverage of the BS associated with the MEC. Each vehicle performs local training on the local multimodal data for a few epochs and determines whether to participate in the global optimization. If a vehicle decides to participate, the vehicle broadcasts the model weights for the overall fusion network (encapsulating four branches, GPS, image, LiDAR, and integration) to the MEC. Meanwhile, the orchestrator at the MEC selects one of the branches as a candidate for federated averaging and transmits back the aggregated weights of the selected branch to the participating vehicles.

### Resilient Inference

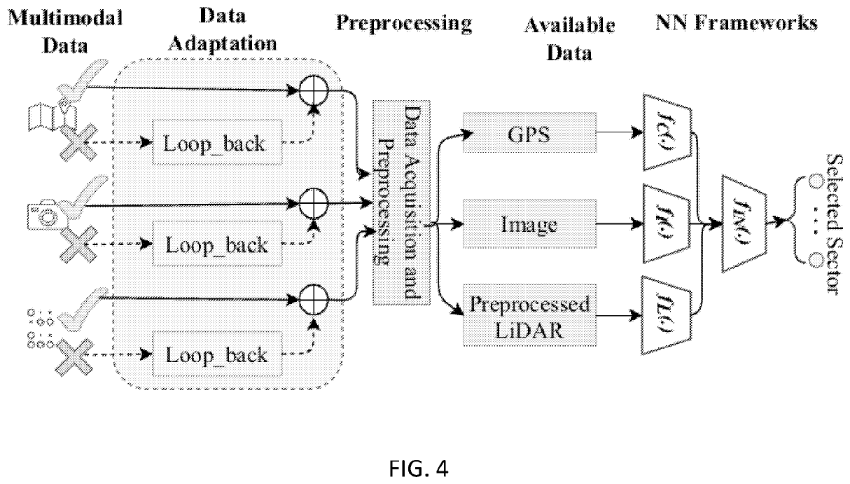

In FLASH, a vehicle receives the globally updated multimodal fusion architecture from the MEC. This model requires inputs from all sensor modalities at any given time. However, this may not be possible due to hardware or software malfunctions that may impair data availability from a specific sensor at a given time. A classical neural network may fail to handle such situations with missing input. Thus, a multimodal data adaptation technique is designed to compensate the missing data from a given sensor with time-shifted copies of earlier data from the same sensor. By using historical information, resilient inference is enabled, with graceful performance degradation. The pipeline of the data adaptation method is shown in FIG. 4. If a sensor data type is unavailable at a particular time instance, the ‘loop-back’ block finds the last available historical data for that sensor and uses that for inference.

### Flash Testbed Setup

FLASH is validated with experimental data collected from an actual autonomous car with multimodal sensors, and mounted with programmable IEEE 802.11ad Talon Routers that operate in the 60 GHz band.

### Testbed Environment and Sensors

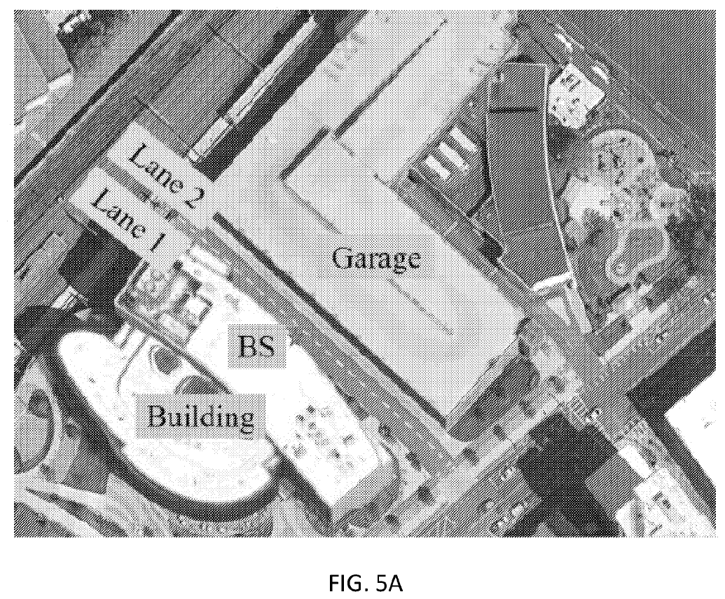

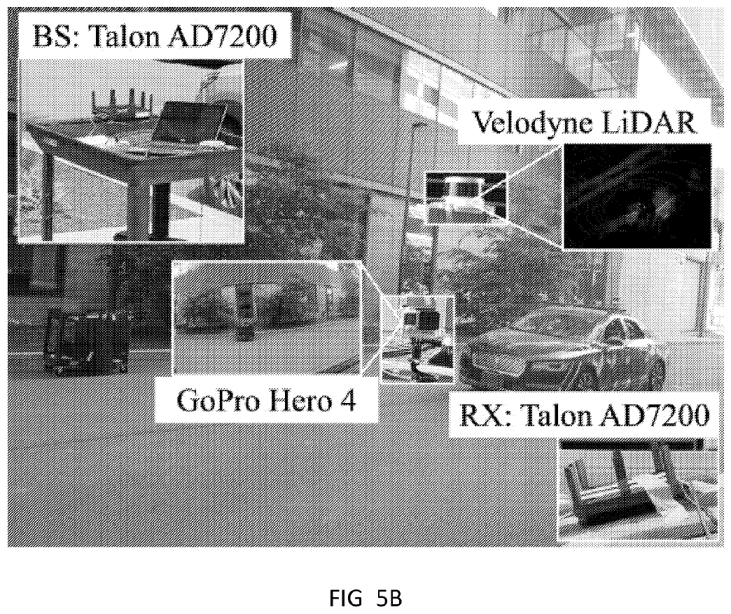

FLASH was demonstrated in a scenario that resembles an urban canyon. The testbed was set up on days with dry, low humidity weather conditions in a metropolitan city on a two-way paved alleyway between two high-rise buildings, as shown in FIG. 5A. The exteriors of the buildings, which are made of brick, metal, and glass, are located at least 4 ft (1.2 m) from either side of the road. There are a few small trees and shrubs planted between the buildings on the sidewalk.

Choice of Sensors: The sensor suite includes a camera, LiDAR, and GPS, which are all attached to a 2017 Lincoln MKZ Hybrid autonomous car. The camera system includes one GoPro Hero4 with a field-of-view (FOV) of 130 degrees. The LiDAR system includes two Velodyne VLP 16 LiDARs with a FOV of 360 degrees. The car is equipped with an onboard computer connected to the LiDAR and GPS sensors, as shown in FIG. 5B. The data is captured at the following rates: 1 Hz for GPS, 30 frames per second (fps) for the camera, 10 Hz for LiDAR, and 1-1.5 Hz for the RF ground truth. Possible errors in GPS accuracy do not affect the system as long as the relative positions of the vehicle during trials are maintained.

TABLE I
Summary of different categories of collected dataset

| | Spd. | | | | | |
|---|---|---|---|---|---|---|
| Cat. | (mph) | Lane | Featuring | Scenarios | # Eps. | # Smpl. |
| 1 | 10, 15, 20 | Same | — | — | 60 | 9729 |
| | | opposite | | | | |
| 2 | 15 | Opposite | Pedestrian | Standing | 50 | 7968 |
| | | | | Walk right to left | | |
| | | | | Walk left to right | | |
| | | | | Walk back to front | | |
| | | | | Walk front to back | | |
| 3 | 15, 20 | Opposite | Static car | On right | 60 | 8174 |
| | | | | On left | | |
| | | | | In front | | |
| 4 | 15, 20 | Opposite | Moving | 10 mph same lane | 40 | 6052 |
| | | | car | 20 mph same lane | | |
| | | | | 10 mph opposite lane | | |
| | | | | 20 mph opposite lane | | |

mm wave Radios: TP-Link Talon AD7200 triband routers are used, which employ Qualcomm QCA9500 IEEE 802.11ad Wi-Fi chips with an antenna array to work as both the

BS and Rx at the 60 GHz frequency. The default codebook includes sector IDs from 1 to 31 and 61-63 for a total of 34 sectors; the sectors with IDs of 32 to 60 are undefined. Access to PHY-layer characteristics of AP and RX is gained using the open-source Linux Embedded Development Environment (LEDE) and Nexmon firmware patching released. The time-synchronized RF ground truth data is recorded as data transmission rate and received signal strength indication (RSSI) at each sector.

### Testbed Settings

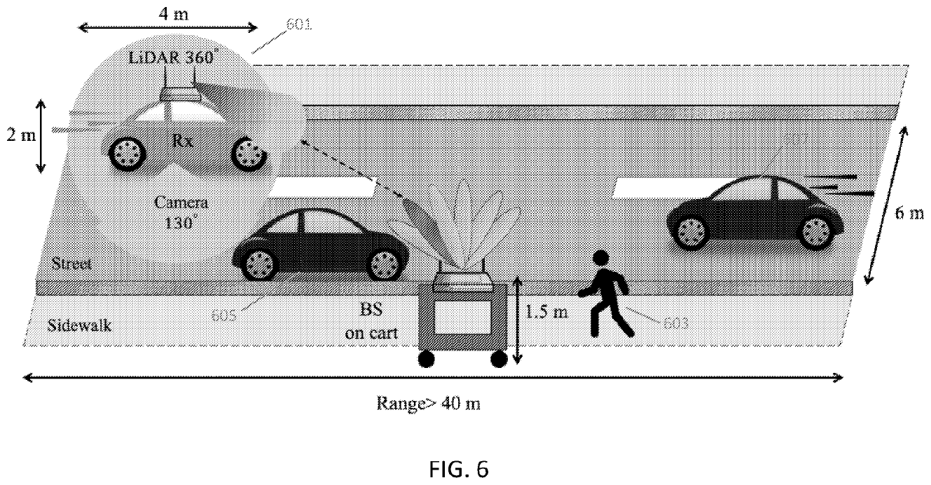

As shown in FIG. 6, four different categories are defined as: LOS passing 601, NLOS with a pedestrian in front of the BS 603, NLOS with a static car in front of the BS 605, and NLOS with a car moving between the Rx and the BS 607 with additional variations as shown in Tab. I. For each scenario, 10 episodes, or trials, are collected with episode durations of approximately 15 seconds. The vehicle's speed is limited to 20 mph, which is typical for inner-city roads.

Image Extraction from Videos: For each of the videos collected with the GoPro the OpenCV python library is used, each video is split up into its individual frames, and each frame is saved as an image with corresponding system timestamps. As an example, for a 15 second video with a frame rate of 30 fps, about 450 images are obtained.

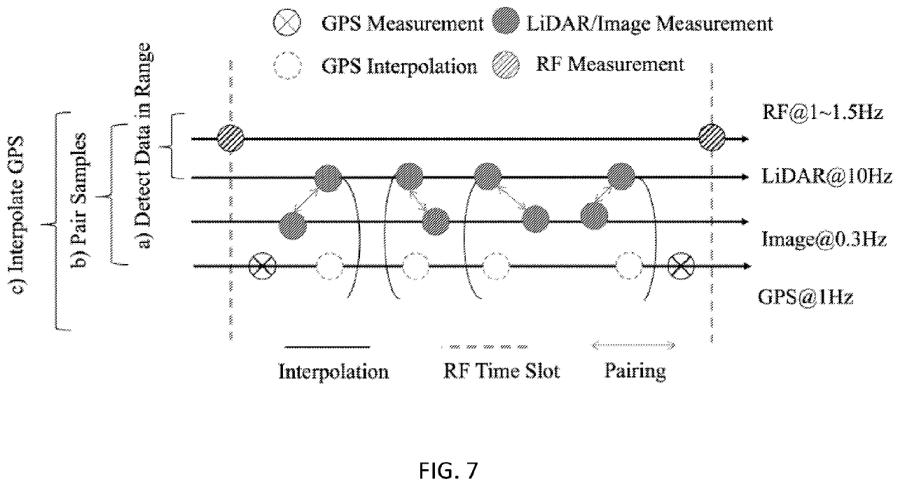

Synchronization: Among the mounted sensors, the camera has the highest sampling rate at 30 fps, whereas LiDAR and GPS have 10 Hz and 1 Hz rates, respectively. According to the 802.11ad standard, sector sweeping is repeated whenever a drop in the received signal power is observed at the Rx, which is an indication of a sector misalignment. As the optimum sector does not change between two consecutive RF measurements, ground truth RF data measurements are up-sampled by associating the same optimum sector to non-RF data between two consecutive RF samples. In particular, the synchronization scheme has three steps as shown in FIG. 7. For each time slot between two RF samples, the scheme includes detection of the LiDAR and image sensor data within the corresponding time slot, pairing of LiDAR sensor data with the closest image and recordation of the timestamp, and, for each timestamp, interpolating the GPS coordinates and recording the RF ground truth data. For GPS interpolation, assuming that the car is moving at a constant speed, the GPS coordinates are first estimated at the time that RF samples are recorded for the target time slot. The GPS coordinates of the two closest points are then detected, say, (lat₁, lon₁), (lat₂, lon₂), and the coordinates at the RF sample timestamp (latₓ, lonₓ) estimated as:

$${lat}_{x} = \{ \begin{matrix}\frac{\frac{n {lat}_{1} + m {lat}_{2}}{n + m}}{\frac{n {lat}_{1} - m {lat}_{2}}{n - m}} & \begin{matrix}if {lat}_{1} < {lat}_{x} < {lat}_{2} \\ o . w .\end{matrix}\end{matrix} \qquad ( 4 )$$

where m=|tₗₐₜ_{₁}−tₗₐₜ_{ₓ}| and n=|tₗₐₜ_{₂}−tₗₐₜ_{ₓ}|. The same equations are used to estimate the longitude.

### Experimental Analysis

In this section, the federated architecture is validated on the FLASH dataset. For experiments, Keras 2.1.6 was used with Tensorflow backend (version 2.2.0).

### Experiment Setting

Dataset: To evaluate the FLASH framework, the entire FLASH dataset is used with 4 different categories and 21 scenarios (inclusive of LOS and NLOS). Each scenario includes 10 episodes or trials of data collection and can be interpreted as having different vehicles. In this way, there are 10 different vehicles, each having a total of 21 different scenarios as their local dataset. During the collection of the FLASH dataset, different episodes of the same scenario are designed to be different, making each local dataset (per vehicle) unique. To replicate real-world situations, local training and validation datasets are created for each vehicle by separating 80% and 10% of the overall local dataset. However, to expose the trained models to the unseen environment detected by other vehicles, a global test dataset is created, where the leftover 10% of each vehicle's local data is combined. The overall dataset contains 25456 and 3180 local training and validation and 3287 global test samples, respectively.

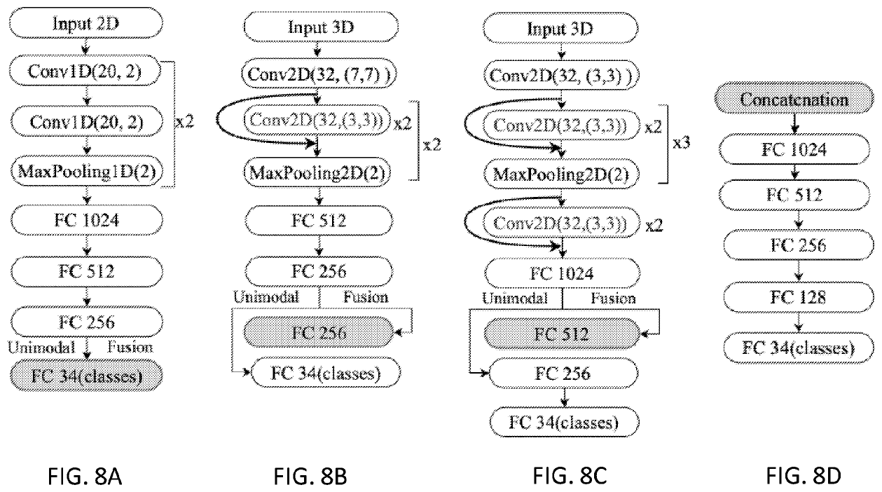

Implementation Details: For all models (see FIGS. 8A-8D), categorical cross-entropy loss is exploited for training with a batch size of 32 for 100 epochs. Adam is used as a primary optimizer with β=(0.9,0.999) and the learning rate initialized to 0.0001. The LiDAR range to be within ±80 m. Each axis is quantized to a (20, 20, 20) block array which corresponds to steps of (2.79, 4.65, 0.5). Moreover, the high quality raw images are resized to (160, 90, 3) for input.

Performance Metrics: Top-K accuracy is the percentage of times that the model includes the correct prediction among the top-K probabilities. The errors in prediction, e.g., selecting a sub-optimal sector, can affect the system performance. Thus, the sector prediction performance is evaluated by defining throughput ratio as

$${R}_{T} = \frac{1}{{N}_{t}^{′}} \sum \begin{matrix}{N}_{t}^{′} \\ n = 1\end{matrix} \frac{{log}_{2} [ 1 + {y}_{\hat{t}} ( n ) ]}{{log}_{2} [ 1 + {y}_{{t}^{*}} ( n ) ]} .$$

Here, t* and \hat{t} denote the best ground truth sector and the predicted sector, respectively, and N′ₜ is the total number of test samples. Intuitively, this metric captures the ratio of degradation in performance compared to the ideal exhaustive search method.

### Comparison with Competing Methods

Using a testbed and setup as described above, the FLASH framework was compared against two other DL approaches in both accuracy and overhead.

Local Learning and Global Inference: The vehicles use their own local training data to optimize the local models, independently. In this method, there is no data sharing; vehicles operate as disjoint independent clients and the training data is confined to their own local data only.

Centralized Learning and Global Inference: The vehicles participate in a data sharing scheme to converge to a generalized model. As a result, V vehicles transmit their own local training data that is centrally collected at the MEC. The latter trains a model on the accumulated training data. This scheme requires a back channel with the required bandwidth for sharing such large amounts of data.

FL and Global Inference (FLASH): The vehicles use only their local training data to optimize their local model. Each vehicle participates in a global model aggregation round, where only the local models are sent to the MEC.

### Local Learning and Global Inference

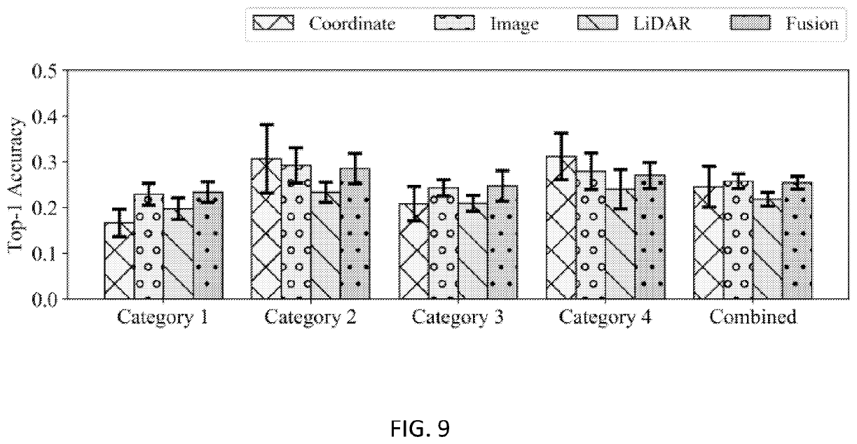

In the first set of experiments, DNNs are trained on the local dataset for each vehicle, separately. During inference, the global test dataset is used to compare the performance. The average achieved accuracy is demonstrated over all 10 vehicles in FIG. 9 for different categories. Results reveal that each model trained on the local dataset fails to achieve competitive performance when exposed to the global test dataset in the inference phase. Additionally, it is observed that both the image and fusion networks give better prediction accuracy than GPS or LiDAR in most cases. Thus, fusion is chosen as the selected architecture for the rest of the experiments, as it enables resilient inference as well. Even though the top-1 accuracies are in the lower range in FIG. 9, it performs comparably better than the random selection accuracy of 0:029 (1 among 34 classes). It is observed that the top-5 and top-10 accuracies vary in the range of 40%-60% and 50%-75%, respectively.

### Centralized Learning and Global Inference

In this set of experiments, the effects of centralized learning on global test data is explored. Considering the local training dataset available at each vehicle, an accumulated training set is constructed by gathering the local training set from V vehicles. The model is then trained using the accumulated training set and tested on the global test set. The result of this experiment is presented in Tab. II, which begins with the data from a single vehicle and increases the accumulated training set by adding the local data from other vehicles, one at a time. A surge in top-1 accuracies is observed as progressively more vehicles are added to the accumulated training set. The incremental improvement after adding one more vehicle is highlighted in the last column. Although this approach improves the robustness of sector selection, it requires all the training data to be gathered at one site (unlike FLASH), e.g., a cloud, with associated transmission cost and privacy concerns.

TABLE II
The top-1 accuracy while training on local dataset of ν =
1, . . . , 10 vehicles and testing on global test set.

| | Top-1 Accuracy (%) | | | | | |
|---|---|---|---|---|---|---|
| | | | | | | Incr. |
| Vehicles | Cat. 1 | Cat. 2 | Cat. 3 | Cat. 4 | Combined | Boost |
| 1 | 22.87 | 28.13 | 24.49 | 33.38 | 26.58 | — |
| 2 | 29.37 | 37.14 | 33.37 | 38.22 | 34.01 | 7.43 |
| 3 | 40.05 | 43.84 | 40.47 | 42.90 | 41.64 | 7.63 |
| 4 | 46.85 | 49.81 | 47.21 | 52.74 | 48.79 | 7.15 |
| 5 | 52.04 | 57.12 | 53.49 | 62.09 | 55.58 | 6.79 |
| 6 | 62.03 | 64.79 | 62.36 | 65.80 | 63.52 | 7.94 |
| 7 | 68.13 | 72.10 | 68.75 | 70.64 | 69.75 | 6.23 |
| 8 | 73.62 | 78.07 | 74.43 | 79.67 | 76.08 | 6.33 |
| 9 | 80.91 | 83.55 | 80.47 | 84.19 | 82.08 | 6.00 |
| 10 | 85.91 | 90.37 | 85.32 | 88.22 | 87.31 | 5.23 |

### Federated Learning and Global Inference (FLASH)

In Alg. 1, the vehicles participate in federated aggregation, where different branches of the models are selected through a multimodal orchestrator. The aggregation policy is based on a stochastic function [symbol] (•), captured by parameters: α, β, γ, δ for GPS, image, LiDAR, and integration networks, respectively. A comprehensive study is conducted on the effect of different policies on top-1 global accuracy. First, with LiDAR being the most successful unimodal network, a greedy LiDAR policy is defined where only the LiDAR branch is aggregated, denoted as [symbol] _{Greedy LiDAR}. In the second policy [symbol] _{L,IN Biased} the LiDAR and integration branches are biased and the LiDAR and integration branches are selected with probability of 0.4 and the GPS and image branches with probability of 0.1. Next, an unbiased policy [symbol] _{Unbiased} is considered where one branch is selected randomly following a uniform distribution. These policies are parameterized as follows:

[symbol]

_{Greedy LiDAR}=(0, 0, 1, 0)

[symbol]

_{L,IN Biased}=(0.1, 0.1, 0.4, 0.4)

[symbol]

_{Unbiased}=(0.25, 0.25, 0.25, 0.25)

A final policy [symbol] _{A11} is also considered where the entire model of the fusion network is averaged and updated without orchestrating any specific branch. It is assumed that all 10 vehicles participate in FL aggregating and run 100 iterations.

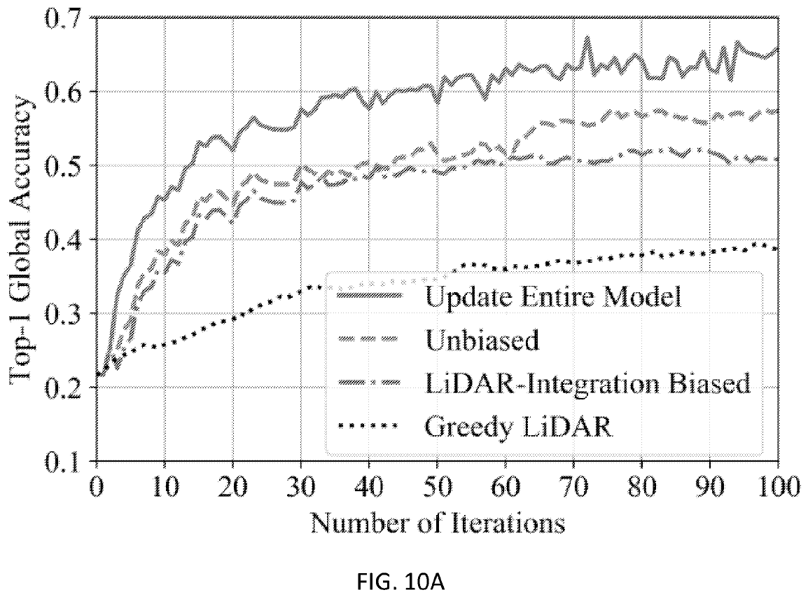

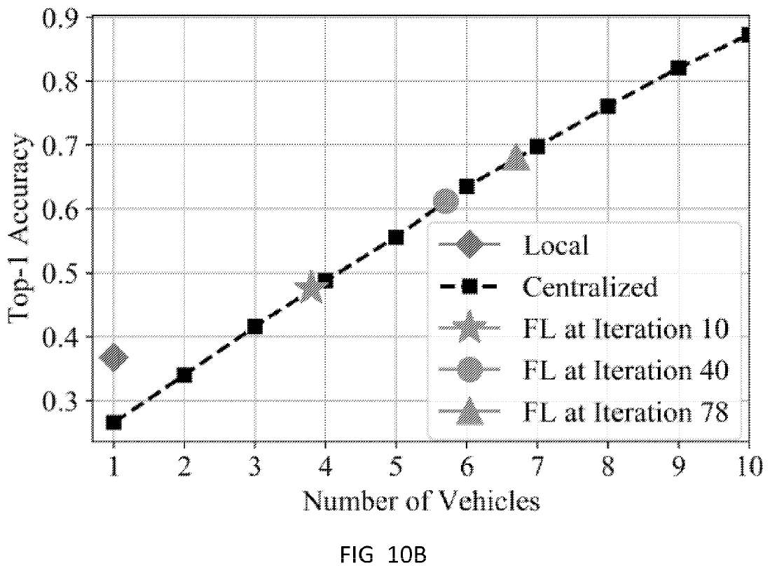

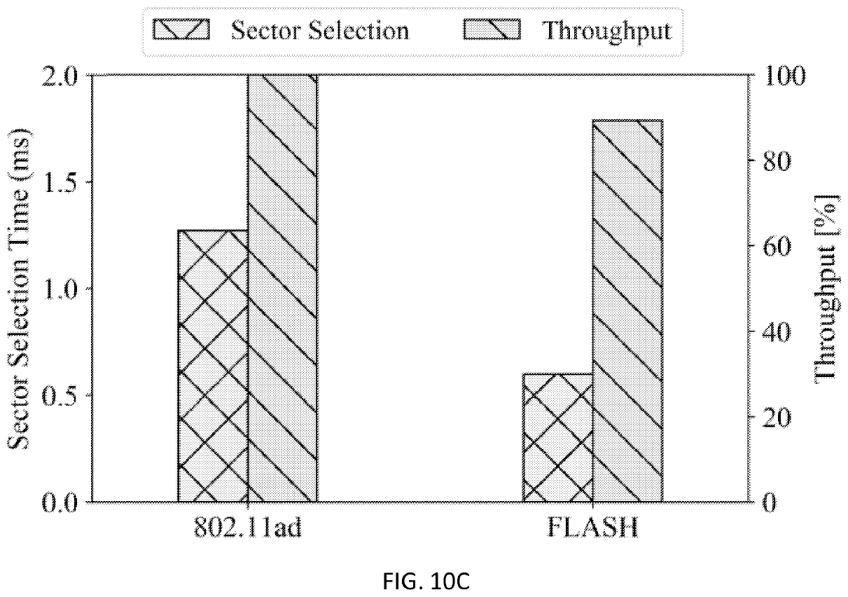

FIG. 10A denotes the improvement in global top-1 accuracy achieved by multiple rounds of aggregating the model weights following the above policies. Although model aggregation improves results for all policies, the lines converge after 50 iterations. In particular, the maximum top-1 accuracy following the policy [symbol] _{A11} is 68.17%. On the other hand, [symbol] _{Greedy LiDAR}, [symbol] _{L,IN Biased}, [symbol] _{Unbiased} policies achieve the top-1 accuracy of 39.42%, 52.23%, and 59.72%, respectively. The size of GPS, image, LiDAR, and integration model branches are 2.78 MB, 26.55 MB, 3.73 MB, and 6.21 MB, respectively. As a result, the corresponding overheads for [symbol] _{Greedy LiDAR}, [symbol] _{L,IN Biased}, [symbol] _{Unbiased} and [symbol] _{A11} policies are 3.73 MB, 6.90 MB, 9.81 MB, and 39.27 MB on average, respectively. In other words, even though the [symbol] _{A11} policy yields to best top-1 accuracy, it imposes 9.52×, 4.69×, and 3× extra overhead than the [symbol] _{Greedy LiDAR}, [symbol] _{L,IN Biased}, [symbol] _{Unbiased} policies, respectively. Hence, the branch selection policy gives the flexibility to use less wireless resources to adhere to user-imposed constraints, such as a threshold on the allowable data-rate over downlink, which is easier to maintain when sending only one branch instead of the entire fusion network.

### Accuracy and Overhead Trade-off

This section begins with a comparison of the accuracies of three competing methods, presented in FIG. 10B. The performance of the local learning method is denoted with a diamond marker. The dashed line indicates the improvement achieved by centralized learning between multiple vehicles at the cost of transmitting all the data to a central unit. The star, dot, and triangle markers show the FL results at iterations 10, 40, and 78. In order to achieve 68.17% top-1 accuracy, the centralized learning requires data from around 7 vehicles, while the FL can achieve the same accuracy without data sharing and with only 78 rounds of aggregation.

TABLE III
Comparing the performance of the three data-driven competing
methods with respect to accuracy and model initialization overhead.
All accuracies are reported on the global test set.

| | | Overhead(s) | |
|---|---|---|---|
| Methodology | Acc. (%) | Data sharing | Model sharing |
| Local Learning | 36.78 | — | — |
| Centralized Learning | 87.31 | 11.54 | 0.1813 |
| FLASH (78 iterations) | 68.17 | — | 3.51 |

However, both the centralized and federated methods impose some communication overhead in the control channel for model initialization. A trade-off between overhead and accuracy is observed for both the methods, as presented in Tab. III. Though the local learning approach does not require any data/model sharing, it provides up to only 36.78% top-1 accuracy. On the other hand, the centralized learning approach can provide 87.31% accuracy, but it comes with a large communication cost of transmitting the entire data (2.5 GB) to the cloud, as well as privacy concerns. Meanwhile, FLASH reduces the communication cost while preserving 68.17% accuracy without any sort of data sharing. FL aggregation iterations continue in the background and do not disrupt the inference. In each aggregation round, one out of four branches is sent back to the vehicles with 696,600 parameters for the lightest branch (here, GPS) and 6,638,368 parameters for the heaviest one (here, images). The back channel is supported by the 5 GHz band of the Talon router with a data rate of 1733 Mbps. Thus, it takes 45 ms on average to retrieve the model in each iteration with unbiased policy, considering 32 bits per model parameter (314.31 Mb overall). For a total of 78 aggregation rounds, the model initialization overhead sums up to 3.51 seconds. Hence, FLASH provides a 46.04% improvement in accuracy over local learning and a 70.05% improvement in overhead over centralized learning.

### Sector Selection Speed and Throughput Ratio

Once it is established that FLASH outperforms the other two competing methods in terms of both accuracy and overhead, the sector selection speed is compared against the current mm wave standards. As described above, in the traditional exhaustive search approach, each sector of BS transmits M probes to initiate the communication. The end-user then returns the optimal sector ID to the BS.

FLASH infers the optimum sector ID from the multimodal sensor data by following four steps: (a) Data acquisition: given the high-sampling rates of COTS sensors, assuming that sensor data is acquired almost instantaneously; (b) Preprocessing: the LiDAR preprocessing step described above has a negligible latency that can be further reduced by exploiting parallel processing; (c) Model inference: a test sample is passed 100 times over the DL model and calculate the average inference delay of 0.6 ms; (d) Sector sharing: an integer varying between 0-31 and 61-63, representing the sector ID with 7 bits, is sent back to the paired users. Considering the 5 GHz back channel of the Talon routers, transmitting the optimal sector back takes only 4 ns. As a result, the FLASH inference consumes ˜0.06 ms end-to-end. On the other hand, sweeping all 34 sectors with the 802.11ad standard in Talon routers takes 1.27 ms. The throughput ratio (defined above) of FLASH and the 802.11ad standard is calculated and shown in FIG. 10C. A 52.75% improvement in sector selection speed was observed while retaining 89.32% throughput ratio.

### Resilient Inference for Missing Sensors

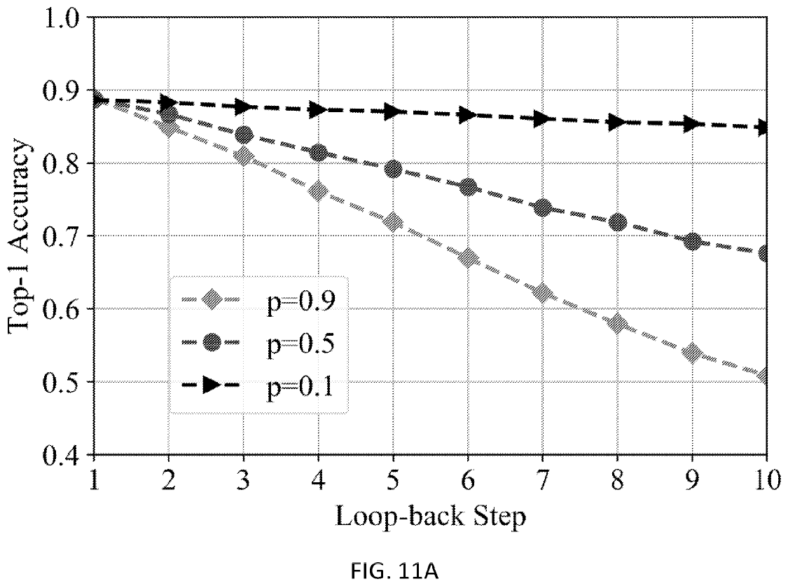

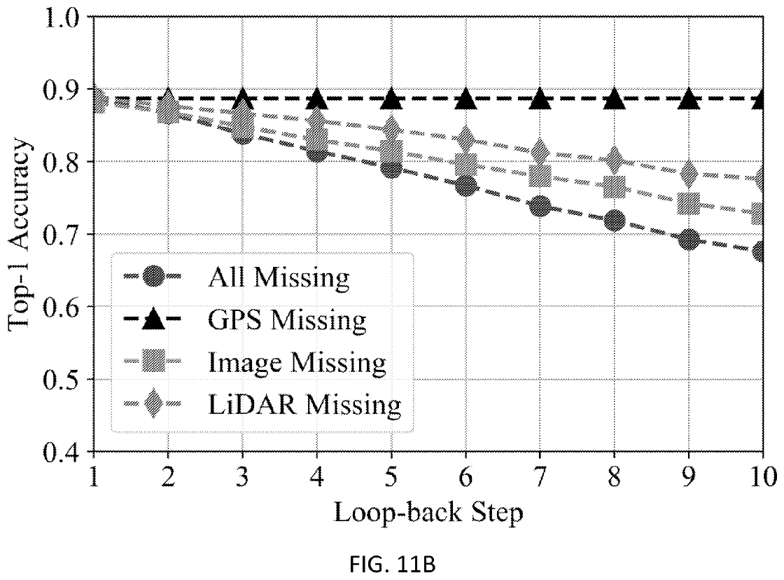

To evaluate the resiliency of FLASH, the extreme scenario in which all the sensor data are missing is considered first. The performance is evaluated with respect to the parameters defined above, namely the loop-back step and probability of missing data in FIG. 11A. It is observed that the top-1 accuracy is resilient to the low loop-back steps and decreases as the loop-back step increases and the samples become far apart. However, the higher probability of missing information results in lower top-1 accuracy. Next, the effect of missing different combinations of sensor data is explored in FIG. 11B, with a fixed probability of 0.5. It is observed that the absence of GPS negligibly affects the performance. One might argue that the LiDAR preprocessing step described above requires the location of the vehicle as input; however, the coordinates can also be estimated using the GPS interpolation scheme presented in Eq. 4. Note that two scenes separated by a small amount of time might result in the same LiDAR data due to quantization, while images are completely different. From FIG. 11B, it is observed that FLASH can retrieve 67.59% top-1 accuracy when up to ten samples are missing for all modalities.

### Comparison With State-of-the-Art

In Tab. IV, the performance of the FL architecture is compared against the state-of-the-art DL-based approaches by Klautau et al. and Dias et al. Both of these techniques use centralized learning with only LiDAR sensors at the vehicle while considering both LOS and NLOS situations on synthetically-generated Raymobtime dataset. The comparison study is limited to the above techniques, as the other state-of-the-art techniques differ from the techniques described herein with respect to various aspects, such as: (a) different evaluation metrics; (b) consideration of LOS only scenarios while using camera sensors; and (c) inclusion the RF inputs (sub-6 GHz channel measurements, for instance). As shown in Tab. IV, FLASH outperforms the state-of-the-art by 35-45% in top-1 accuracy.

TABLE IV
Comparison of FLASH with state-of-the-art techniques
which use non-RF data for similar tasks.

| | | | Top-1 | | Evaluation | |
|---|---|---|---|---|---|---|
| Methods | Modalities | Architecture | Acc. (%) | Dataset | Type | Task |
| Klautau et al. | LiDAR | Centralized | 30.5 ± 1 | Synthetic | Simulation | Beam |
| | | | | Raymob-time | | Prediction |
| Dias et al | LiDAR | Centralized | 20.5 ± 1 | Synthetic | Simulation | Beam |
| | | | | Raymob-time | | Prediction |
| FLASH | GPS, Image | Distributed | 68.17 | FLASH | Testbed | Sector |
| | LiDAR | | | Dataset | | Selection |

As explained above, the methods and systems described herein benefit from the new framework using multiple sensor modalities to aid in mm wave beamforming, in contrast to conventional methods, which use only RF-based approaches. FLASH incorporates multimodal data fusion using DL architectures, whose training and dissemination in real-world vehicular networks, as well as resilience to missing data sources, can be practically achieved using a FL architecture. Results obtained on datasets collected by an autonomous vehicle with LiDAR, GPS, and camera sensors indicate a 52.75% reduction for mm wave sector selection time while retaining 89.32% of throughput as compared to the traditional sector sweeping.

### Example Features

The inventors have designed robust DL architectures that predict the best sector using non-RF sensor data from devices such as GPS, camera, and LiDAR, wherein the processing steps are contained within the semi-autonomous edges (vehicles). They show that adding more viewpoints in the training data enhances the performance of sector selection and analyze the resulting control overhead.
The inventors have introduced FLASH, a multimodal FL framework, where local DL model weights are globally optimized by fusing them at the MEC. So far, the state-of-the-art in FL has focused on unimodal data, which suggests that FLASH may be suitable for other generalized problems involving multiple data types (beyond mm wave beamforming).
Herein is described a multimodal data adaptation technique that is executed in the individual vehicles, making FLASH resilient to missing sensor information. The inventors observe 67.59% top-1 accuracy even when all sensors are missing for 10 consecutive samples.
The inventors rigorously analyzed the end-to-end latency of FLASH and compare it with IEEE 802.11ad standard and demonstrate that sector selection time decreases by 52.75% on average while maintaining 89.32% of the throughput. Due to lack of access to programmable cellular 5G mm wave BS and clients, they use two 802.11ad-enabled mm wave Talon routers to evaluate FLASH on real-world scenarios. Without loss of generality, FLASH can be applied to other bands and wireless standards.
The present technology provides what is believed to be the first dataset collected by an autonomous vehicle mounted with multimodal sensors and mm wave radios for community use. The dataset includes comprehensive settings of LOS and NLOS scenarios for the urban canyon region.

### Example Advantages

The technology presents a robust and faster machine learning based sector selection mechanism for high band mm wave communication, where the current state-of-the-art incurs significant amount of overhead. This technology reduces the overhead imposed by IEEE 802.11ad to 52%.
The technology presents a federated learning-based framework to restrict the sensor data sharing among vehicles in nextG v2X communication while performing sector selection in mm wave band.
The technology presents a federated learning framework which uses multimodal sensing data stochastically to improve the overall performance of the sector selection task. This multimodal federated learning framework has also the potential to be used in different application areas beyond wireless communication.
The technology uses the existing sensors (LiDAR, camera, GPS: which are already deployed in the modern autonomous vehicles) and mm wave radios (which are envisioned to be integrated with the future autonomous vehicles) of the vehicle. The software and the architecture can be integrated with the future mm wave based V2X communication system.

### Example Industrial Applications and Benefits

Ultra-low latency and ultra-high bandwidth communication.
Next generation vehicle-to-everything communication.
Ultra-fast AR/VR streaming platforms.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A method for selecting a mm wave network sector for use by a vehicle operating within a network environment, the method comprising:
collecting data from a plurality of non-RF sensors on the vehicle;
training, by the collected data in a deep learning inference (DL) engine, a locally trained model;
analyzing, using the trained model and the DL engine, the collected data to predict a sector of the mm wave network having a best alignment at a position of the vehicle; and
probing the predicted sector of the mm wave network.

2. The method of claim 1, wherein the step of probing further comprises:
receiving a test sample from a mobile edge computing (MEC) node of the network environment; and
passing the test sample through the local model via the DL engine to calculate an average inference delay of the network environment.

3. The method of claim 1, wherein the plurality of non-RF sensors includes at least one of a LIDAR, a GPS, still images, video, or combinations thereof.

4. The method of claim 1, further comprising providing the local multimodal model to a mobile edge computing (MEC) node of the network environment for aggregation to a global shared model.

5. The method of claim 4, further comprising receiving, from the MEC node, at least a portion of the aggregated global shared model.

6. The method of claim 1, further comprising collecting data from a plurality of non-RF sensors on at least one different vehicle operating within the network environment.

7. The method of claim 5, wherein the step of analyzing the collected data includes analyzing the data collected from both the vehicle and the at least one different vehicle.

8. The method of claim 1, further comprising providing the data collected from the plurality of non-RF sensors on the vehicle to at least one different vehicle operating within the network environment.

9. The method of claim 2, wherein the step of training the locally trained model includes executing an algorithm:
```
Input: Intial parameters θᵥ^{FN(0)} = θ^{FN(0)} ∀v ∈ V(at vehicles)
    P = {α, β, γ, δ}, where α + β + γ + δ = 1 (at MEC)
  Output: Trained global model weights θᵥ^{B(i)}
  For each i = 1 ... N do
  θᵥ^{FN(i)} = local training for ξ ephs on θᵥ^{FN(i-1)} (at vehicles)
  Each participant vehicle v shares θᵥ^{FN(i)} to MEC
  Assign four branches B_{c}⁽ⁱ⁾, B_{I}⁽ⁱ⁾, B_{L}⁽ⁱ⁾, B_{IN}⁽ⁱ⁾ within θᵥ^{FN(i)}
  B(i) = P_{P}(B_{c}⁽ⁱ⁾, B_{I}⁽ⁱ⁾, B_{L}⁽ⁱ⁾, B_{IN}⁽ⁱ (at MEC)
  MEC computes
  ${θ}^{B ( i )} = \frac{1}{\vert V \vert} {\sum }_{v = 1}^{V} {θ}_{v}^{B ( i )}$
  MEC distributes θ^{B(i)} such that θᵥ^{B(i)} = θ^{B(i)} ∀v ∈ V
  End
```
wherein the Intial parameters θᵥ^{FN(0)} are determined from the collected data.

10. A system for selecting a mm wave network sector for use by a vehicle operating within a network environment, the system comprising:
a plurality of non-RF sensors mounted on the vehicle;
a mm wave receiver mounted on the vehicle; and
an analysis module programmed to perform the method of claim 1.

11. The system of claim 10, wherein the plurality of non-RF sensors includes at least one of a LIDAR, a GPS, still images, video, or combinations thereof.

12. The system of claim 10, further comprising:
a plurality of the vehicles, wherein each vehicle includes a plurality of non-RF sensors and a mm wave receiver mounted thereon; and
a mobile edge computing (MEC) node programmed to:
collect the local model from each of the plurality of vehicles
aggregate the local models to at least one branch of a plurality of weighted branches of the global shared model according to previous-iteration model weights to generate at least one updated branch of the global shared model; and
disseminate the updated branch or branches to the vehicles.

13. The system of claim 12, wherein the MEC assigns four different branches within the current model weights θᵥ^{FN(i)} and chooses one of them B(i) using the stochastic function P_{P}(•).

14. The system of claim 13, wherein the weights of the selected branch B(i) of each received model are averaged by the MEC and sent back to the participating vehicles.

15. The system of claim 14, wherein each vehicle responsively updates the selected branch of their local models and executes the local training for the next federated iteration.

16. The system of claim 13, further comprising an orchestration module for executing the choosing of the branch B(i) using the stochastic function.

17. The system of claim 11, wherein the collected data includes GPS, camera, and LiDAR data, sorted as a local dataset Dᵥ={X_{C,v},X_{I,v},X_{L,v}}ᵥ₌₁^{v}.

18. The system of claim 17, wherein a data matrix for GPS, image, and LiDAR at the vehicle v is expressed as X_{C,v}∈ [symbol] ^{N}^{ₜ}^{×2}, X_{I,v}∈ [symbol] ^{N}^{ₜ}^{×d}^{₀}^{^{I}}^{×d}^{₁}^{^{I}},X_{L,v}∈ [symbol] ^{N}^{ₜ}^{×d}^{₀}^{^{L}}^{×d}^{₁}^{^{L}}^{×d}^{₂}^{L} respectively, where Nₜ is the number of training samples.

19. The system of claim 18, wherein:
dimensionality of collected image data is expressed as (d₀^{I}×d₁^{I}); and
dimensionality of preprocessed lidar data is expressed as (d₀^{L}×d₁^{L}×d₂^{L}).
